(19) United States
(12) Patent Application Publication
(10) Pub. No.: US 2010/0015866 A1
(43) Pub. Date: Jan. 21, 2010

(54) STRUCTURE OF COMPONENT FOR FLOATING PRODUCTS AND METHOD THEREFOR

(75) Inventors: Adriano Vignudelli, Spilamberto (IT); Lorenzo Nencini, Firenze (IT)

Correspondence Address: DENNISON, SCHULTZ & MACDONALD, 1727 KING STREET, SUITE 105, ALEXANDRIA, VA, 22314, US

(73) Assignee: INCOM S.P.A., Pieve a Nievole (IT)

(21) Appl. No.: 12/307,137

(22) PCT Filed: Jul. 5, 2007
(86) PCT No.: PCT/IB07/01862

§ 371 Date: Sep. 9, 2009

(30) Foreign Application Priority Data
Jul. 5, 2006 (IT) PI2006A000079

(51) Int. Cl. B63C 9/08; A41D 13/012; B32B 7/08; D05B 3/12; B32B 7/00

(52) U.S. Cl. 441/88; 428/198; 428/212; 112/440; 112/475.08

(57) ABSTRACT

Structure of semifinished product (10) for floating products comprising a plurality of layers (1a-Id) of flexible material having density less than water, for example foam polyethylene, mutually constrained to each other. In particular, the layers (1a-Id) are arranged according to an overlapped configuration and then constrained at fastening points, for example, seams (6) made by a stitching head (50) equipped with one or more needles (55) acting along a direction (60) substantially orthogonal to the layers (1a-Id). Each seam point (6) is, in particular, insulated, i.e. is made in order to result distanced from the other seams (6). This is to avoid the production of weakening lines, or zones, in the semifinished product (10) and to obtain, then a highly flexible product and at the same time having a high mechanical resistance. The seams (6) can be made in a random way or following a predetermined scheme to provide a homogeneous distribution on all the surface of the layers (1a-Id). Certain seams (6) can be connected by a segment of thread (7) in order to reduce the number of cutting operations in the seaming process.

### FIELD OF THE INVENTION

The present invention relates to a structure of stratified material to provide floating and impermeable products, for example safety jackets.

The invention relates, furthermore, to a method for making such a semifinished product.

### DESCRIPTION OF THE PRIOR ART

As well known, a variety exists of types of semifinished products used to provide floating objects of different types such as safety auto-inflatable jackets, often provided in safety equipments of watercrafts, but also to provide products used in aquatic environment or for the beach such as air beds, floating bags for fishing, etc.

However, the semifinished products of this type used for making garments adapted to allow to an user to float in an aquatic environment do not allow moving freely and easily, and constrain remarkably the limbs of the user.

An example of a semifinished floating product solving these problems is described in EP690805. In particular, a semifinished product is described comprising layers of different material kept together by means of seam lines or quiltings in order to provide a plurality of strips of measured width, the seam lines defining zones where air is trapped, thus increasing floatability.

However, even if using highly flexible material, the stratified product resulting therefrom, obtained as above described, does not allow in any case free movements for the presence of the seam lines that prevent movements in directions to them orthogonal. Furthermore, the seams are tear-off lines along which the risk is very high of tearing the material.

Furthermore, the quiltings leave the strips of material comprised between them not connected by anything, whereby a longitudinal tearing of the seam can propagate freely breaking up the material.

Another example of floating fabric is defined in DE U 9207143, mounted on swimsuits. The tissue is made with more layers of floating material enclosed in a coating layer and united to each other by a zigzag seam. Furthermore, a connection is provided along the edge of the garment by means of pressure bonding. The material obtained in this way has similar drawbacks of the previously cited EP690805.

### SUMMARY OF THE INVENTION

It is therefore a feature of the invention to provide a structure of semifinished floating product adapted to allow a higher freedom of movement with respect to the products of the prior art when used to make garments.

It is another feature of the invention to provide a structure of semifinished floating product that has not tear-off lines risking to break up the material.

It is also a feature of the invention to provide a structure of semifinished floating product that has a high flexibility and a considerable impermeability.

These and other features are accomplished with one exemplary structure of semifinished floating product, according to the invention, said structure comprising a plurality of layers of flexible material having density substantially less than water, whose main feature is that said plurality of layers are mutually constrained at a plurality of isolated fastening points.

In particular, each fastening point is in general free and distanced from the other points.

Preferably, the fastening points are seams, for example made by means of needling.

In this case, at least two fastening points can be connected by a seam thread.

In particular, between two adjacent layers of the plurality of layers the introduction can be provided of a stiffening sheet, for example a woven sheet, in order to increase the resistance of the semifinished product and avoid lacerations and damages to the final product during use.

Advantageously, the semifinished product made as above described can be used for packaging floating products, in particular, wearable products such as life jackets. This can be obtained both cutting out and stitching directly the semifinished product using known techniques in the textiles field, both using the semifinished product as padding for floating products.

In particular, the plurality of layers is arranged between a first and a second protection sheet, made for example of a non woven fabric, to assist handling the semifinished product along the production line and avoid tearing and breaking up the semifinished product same during fastening operations.

Advantageously, the flexible material is selected from the group comprised of:
foam poliethylene,
foam poliurethane,
foam polivinylchloride (PVC).

In particular, the isolated fastening points are made at a distance set between 1 and 7 cm and preferably at a distance set between 3 and 5 cm.

Advantageously, each isolated fastening point comprises a plurality of grouped stitches, each said plurality of grouped stitches being distanced from the other pluralities of grouped stitches at a distance set between 1 and 7 cm and preferably at a distance set between 3 and 5 cm.

According to another aspect of the invention, a method for making a semifinished floating product comprises the following steps:
arranging a plurality of layers of flexible material having density substantially less than water in an overlapped configuration in order to provide a stack of layers,
mutually fixing said layers at isolated fastening points.

Advantageously, before the fastening step the arrangement is provided of a first and a second protection sheet out of the stack of layers.

In particular, the fixing of the stacked layers is made along a direction substantially orthogonal the stacked layers by a head equipped with a needle adapted to provide corresponding seams layers.

Advantageously, the semifinished product obtained as above described can be cut into portions having determined shape and size, each of which with of flexibility and floating features unchanged with respect to the original semifinished product, to provide various parts of a wearable product.

### BRIEF DESCRIPTION OF THE DRAWINGS

The invention will be now shown with the following description of an exemplary embodiment thereof, exemplifying but not limitative, with reference to the attached drawings, in which:

figures from 1 to 3 show diagrammatically a perspective view of some steps of the method for making a structure of semifinished floating product, according to the invention;

FIG. 4 shows the structure of semifinished floating product in a cross sectional view according to arrows IV-IV of FIG. 3;

FIGS. 5 and 6 show two possible exemplary embodiments of the structure of semifinished product of FIG. 3;

FIG. 7 shows an elevational front view of a possible wearable floating product obtainable using the semifinished product, according to the invention;

FIG. 8 shows a perspective elevational side view of a further exemplary embodiment of the semifinished product of FIG. 3;

FIG. 9 shows an exemplary embodiment according to a cross sectional view according to arrows VIII-VIII of FIG. 8.

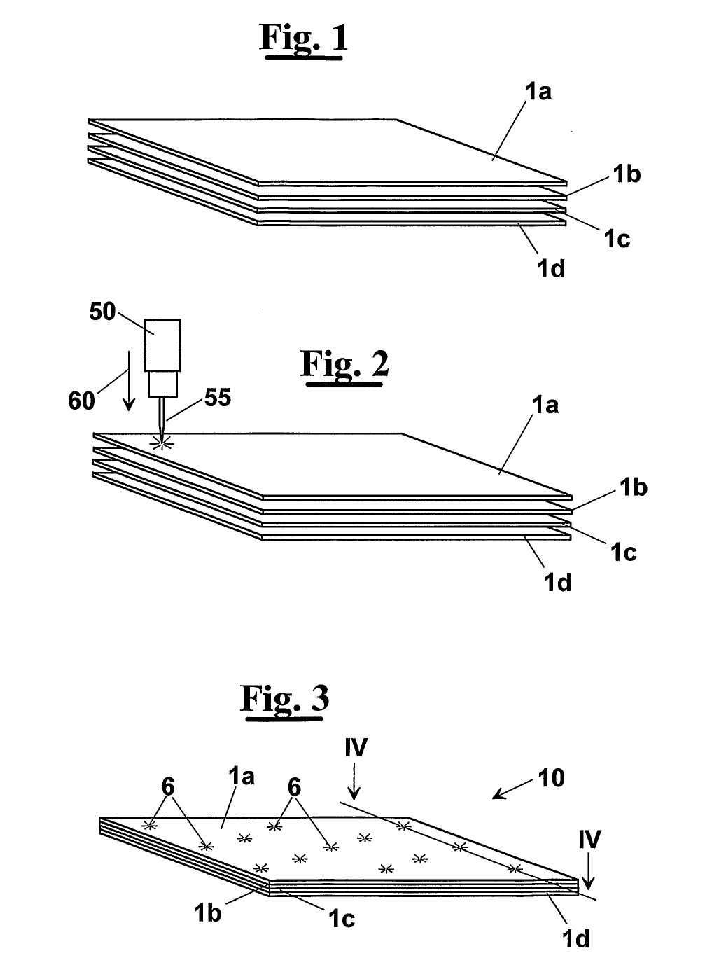

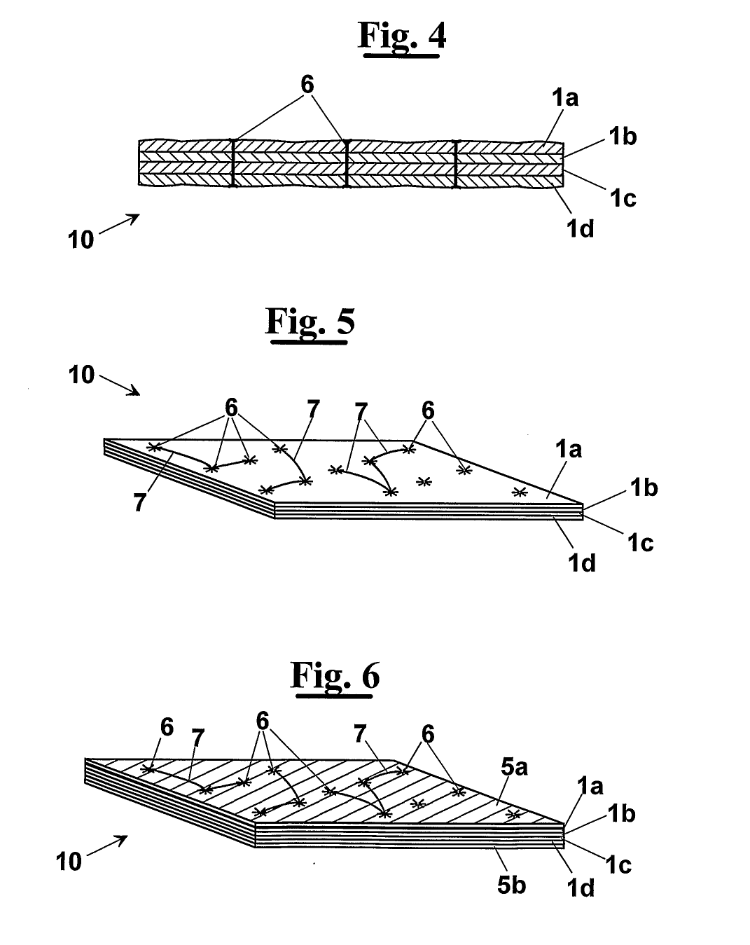

### DESCRIPTION OF THE PREFERRED EMBODIMENTS

With reference to figures from 1 to 3, the structure of semifinished product 10 for floating products, according to the invention, provides a plurality of layers 1a-1d of flexible material having density less than water, for example foam polyethylene, mutually constrained to each other.

In particular, the layers 1a-1d are arranged according to an overlapped configuration (FIG. 1) and then constrained at isolated fastening points (FIG. 2). The fastening points can be, for example, seams made by a stitching head 50 equipped with one or more needles 55 acting along a direction 60 substantially orthogonal to layers 1a-1d.

Each seam point 6 is in general insulated, i.e. it is made in order to result distanced from the other seams 6. This is made to avoid the production of weakening lines, or zones, in the semifinished product 10 and to obtain, then, a highly flexible product at the same time having a high mechanical resistance. Seams 6 can be carried out in a random way or following a predetermined scheme to provide a homogeneous distribution on all the surface of layers 1a-1d. Some seams 6 can be connected by a segment of thread 7 in order to reduce the number of cutting operations of the seaming procedure.

In an exemplary embodiment shown in FIGS. 8 and 9, between two adjacent layers of the stack a stiffening sheet 15 is arranged, for example a woven sheet. This provides a semifinished product 10 having a higher resistance in order to avoid lacerations and damages during use, without affecting the flexibility of the final product and therefore the freedom of movement of the user.

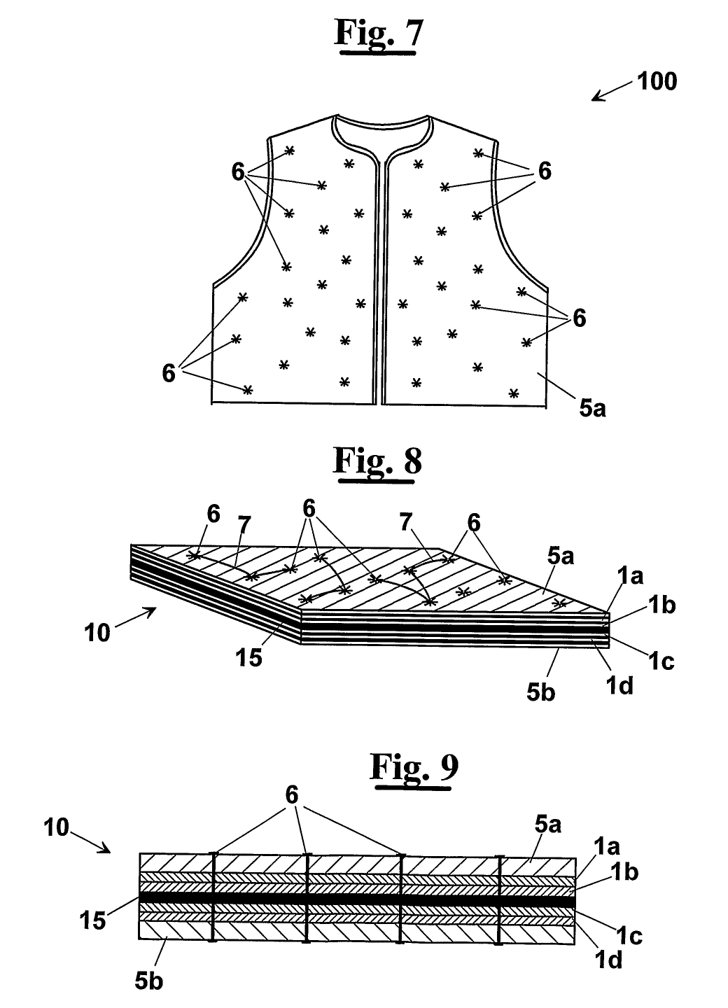

The semifinished product 10 made as above described can be advantageously used to make wearable floating products, such as safety jackets 100 (FIG. 7), capable of assuring a high freedom of movement to the user that wears it in addition to ensuring a high mechanical resistance. Wearable product 100, can be made by cutting out and stitching directly the semifinished product 10 according to operations well known in the field of textiles, without affecting the impermeability, flexibility and floatability. Alternatively, the semifinished product 10 can be used as padding for floating products of many kinds.

Before the fixing step by means of a seams 6, the layers 1a-1d are arranged between two protection sheets 5a and 5b adapted to avoid damages during this critical step.

The isolated seams are made at a distance from each other for example set between 1 and 7 cm, preferably between 3 and 5 cm. Furthermore, notwithstanding reference has been made to isolated points, this terminology include also the case of a few stitched points that are grouped in order to look like a single point, or an plurality of very concentrated grouped stitches, each unit being distanced from the other at the above described distance.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

1. Structure of semifinished floating product comprising a plurality of overlapped layers of flexible material having density substantially less than water, characterised in that said layers of flexible material are mutually constrained at a plurality of isolated fastening points.

2. Structure of semifinished floating product, according to claim 1, wherein said fastening points are made by means of a seam.

3. Structure of semifinished floating product, according to claim 2, wherein at least two of said fastening points are connected by seam thread.

4. Structure of semifinished floating product, according to claim 1, wherein has at least one stiffening sheet located between two adjacent layers of said plurality, said or each stiffening sheet being of a material different from that of said layers.

5. Structure of semifinished floating product, according to claim 4, wherein said stiffening sheet is made by weaving.

6. Structure of semifinished floating product, according to claim 1, wherein said plurality of layers of flexible material is arranged between a first and a second protection sheet.

7. Structure of semifinished floating product, according to claim 6, wherein said protection sheet is made of non woven fabric.

8. Structure of semifinished floating product, according to claim 1, characterised in that said semifinished floating product is used as padding for wearable floating products.

9. Wearable floating product characterised in that of being packaged starting from a semifinished product obtained according to claim 1.

10. Structure of semifinished floating product, according to claim 1, wherein said flexible material is selected from the group comprised of:
foam polyethylene,
foam polyurethane,
foam polyvinylchloride (PVC).

11. Structure of semifinished floating product, according to claim 1, wherein said plurality of isolated fastening points are arranged at a distance set between 1 and 7 cm and preferably at a distance set between 3 and 5 cm.

12. Structure of semifinished floating product, according to claim 1, wherein each said isolated fastening point comprises a plurality of grouped stitches, each said plurality of grouped stitches being distanced from the other pluralities of grouped stitches at a distance set between 1 and 7 cm and preferably at a distance set between 3 and 5 cm.

13. Structure of semifinished floating product comprising a plurality of overlapped layers of flexible material having density substantially less than water, characterised in that it has at least one stiffening sheet located between two adjacent layers, said stiffening sheet being of a material different with respect to that of said layers, said overlapped layers and said at least one stiffening sheet being mutually constrained.

14. Structure of semifinished floating product, according to claim 13, wherein said overlapped layers and said at least one stiffening sheet are mutually constrained at fastening points.

15. Method for making a semifinished floating product comprising the following steps:
arranging a plurality of layers of flexible material of density substantially less than water in an overlapped configuration in order to provide a stack of layers,
mutually fixing said layers of said stack, characterised in that said fixing is made at isolated fastening points.

16. Method, according to claim 15, wherein said fixing is effected by a head of application equipped with at least one needle acting in a direction substantially orthogonal to said layers and adapted to provide seams at determined positions.

17. Method, according to claim 15, wherein said fixing is effected by a head of application equipped with at least one needle acting in a direction substantially orthogonal to said layers and adapted to provide seams by moving with respect to it in a random way.

18. Method, according to claim 15, wherein preliminarily to said fastening step the arrangement is provided of a first and a second protection sheet out of said stack of layers, said first and said second protection sheet being adapted to avoid damaging said layers during the following fastening step.

19. Method, according to claim 15, wherein said step of arranging said layers in an overlapped configuration is followed by a step of arranging a stiffening sheet between at least two consecutive layers.

20. Method, according to claim 15, wherein a step it is further provided wherein said semifinished product is cut into portions with determined shape and size.
